(19) United States
(12) Patent Application Publication
(10) Pub. No.: US 2026/0274200 A1
(43) Pub. Date: Sep. 17, 2026

(54) WEBBING TAKE-UP DEVICE

(71) Applicant: KABUSHIKI KAISHA TOKAI-RIKA-DENKI-SEISAKUSHO, Aichi-ken (JP)

(72) Inventors: Ryuji YAMAGUCHI, Aichi (JP); Yasunori HATA, Aichi (JP); Hitoshi TAKAMATSU, Aichi (JP)

(73) Assignee: KABUSHIKI KAISHA TOKAI-RIKA-DENKI-SEISAKUSHO, Aichi-ken (JP)

(21) Appl. No.: 19/561,531

(22) Filed: Mar. 10, 2026

(30) Foreign Application Priority Data
Mar. 17, 2025 (JP) 2025-042736

(51) Int. Cl. B60R 22/36

(52) U.S. Cl. CPC B60R 22/36

(57) ABSTRACT

In a webbing take-up device, a sensor mechanism actuates a lock mechanism, and the lock mechanism locks rotation of a spool in a pull-out direction. A transmission gear of the sensor mechanism meshes with a shaft gear that is on the same shaft as the spool, rotation of the shaft gear is transmitted to the transmission gear, and the transmission gear is rotated. This thereby enables the webbing take-up device to be made more compact in the axial direction of the spool compared to cases in which the shaft gear and the transmission gear are arranged coaxially.

### CROSS-REFERENCE TO RELATED APPLICATION

This application is based on and claims priority under 35 USC 119 from Japanese Patent Application No. 2025-42736 filed on Mar. 17, 2025, the disclosure of which is incorporated by reference herein.

### BACKGROUND

### Technical Field

The present invention relates to a webbing take-up device in which a lock mechanism is actuated to lock rotation of a spool in a pull-out direction.

### Related Art

In a seatbelt retractor described in Japanese Patent Application Laid-Open (JP-A) No. 2024-508781, a pilot lever of a sensor device engages with a steering disk, and rotation of a spindle in a pull-out direction is locked.

There is no description here of a configuration to couple the steering disk to the spindle in this seatbelt retractor.

### SUMMARY

In consideration of the above circumstances, an object of the present invention is to obtain a webbing take-up device that can be made more compact in an axial direction of a spool.

A webbing take-up device of a first aspect of the present invention includes a spool that is configured to take up webbing fitted over an occupant by being rotated in a take-up direction, and to be rotated in a pull-out direction by the webbing being pulled out; a first gear that is configured to be rotated as a single body with the spool; a lock mechanism that is configured to lock rotation of the spool in the pull-out direction when actuated; an actuation mechanism that is configured so as to actuate the lock mechanism; and a second gear that is provided at the actuation mechanism, and that is coupled to the first gear and rotated by transmission of rotation of the first gear.

In the webbing take-up device of the first aspect of the present invention, the spool is rotated in the take-up direction and the webbing fitted over the occupant is taken up on the spool, and the spool is rotated in the pull-out direction by the webbing being pulled out from the spool. Furthermore, the actuation mechanism actuates the lock mechanism, and the lock mechanism locks rotation of the spool in the pull-out direction. Moreover, the first gear rotates as a single body with the spool, and the second gear is provided at the actuation mechanism.

The second gear is coupled to the first gear, rotation of the first gear is transmitted to the second gear, and the second gear is rotated. This means that, in contrast to cases in which the second gear is arranged coaxially to the first gear, the webbing take-up device can be made more compact in the axial direction of the spool.

A webbing take-up device of a second aspect of the present invention is webbing take-up device of a first aspect of the present invention, further including an actuation member that is provided at the actuation mechanism, and that is configured as a single body with the second gear, the lock mechanism being actuated when the actuation member is rotated while in a state of being coupled to the lock mechanism.

In the webbing take-up device of the second aspect of the present invention, the lock mechanism is actuated when the actuation member of the actuation mechanism is rotated while in a state of being coupled to the lock mechanism.

The actuation member is configured as a single body with the second gear. This thereby enables configuration to be simplified.

A webbing take-up device of a third aspect of the present invention is the webbing take-up device of the first aspect or the second aspect of the present invention, further including a locked-onto member that is provided at the lock mechanism, and that is rotated as a single body together with the spool, rotation of the locked-onto member in the pull-out direction being locked by actuation of the lock mechanism.

In the webbing take-up device of the third aspect of the present invention, the locked-onto member of the lock mechanism is rotated as a single body with the spool.

The lock mechanism is actuated and rotation of the locked-onto member in the pull-out direction is locked. This thereby enables locking of rotation of the spool in the pull-out direction.

A webbing take-up device of a fourth aspect of the present invention is the webbing take-up device of the third aspect of the present invention, further including a support body that rotatably supports the spool, the locked-onto member passing through a wall of the support body.

In a webbing take-up device of a fourth aspect of the present invention, the support body rotatably supports the spool.

The locked-onto member is passed through a wall of the support body. This means that, in contrast to cases in which the locked-onto member is arranged entirely at the outer side of the wall of the support body, the webbing take-up device can be made more compact in the axial direction of the spool.

The webbing take-up device of a fifth aspect of the present invention is the webbing take-up device of the fourth aspect of the present invention, further including a lock section that is provided at the support body at a webbing pull-out side of the locked-onto member, and that is configured to lock rotation of the locked-onto member in the pull-out direction when engaged with the locked-onto member.

In the webbing take-up device of the fifth aspect of the present invention, the lock section is provided at the support body at the webbing pull-out side of the locked-onto member, and the lock section locks rotation of the locked-onto member in the pull-out direction when the locked-onto member is engaged with the lock section. This thereby enables rotation of the spool in the pull-out direction to be locked effectively.

A webbing take-up device of a sixth aspect of the present invention is the webbing take-up device of any one of the first aspect to the fifth aspect of the present invention, further including a support body that rotatably supports the spool, the first gear being adjacent at an inner side of the support body.

In the webbing take-up device of the sixth aspect of the present invention, the support body rotatably support the spool.

The first gear is adjacent at the inner side of the support body. This thereby enables the inner side face of the support body and the first gear to be brought into proximity to each other, enabling the webbing take-up device to be made more compact in the axial direction of the spool.

A webbing take-up device of a seventh aspect of the present invention is the webbing take-up device of any one of the first aspect to the sixth aspect of the present invention, wherein a gear ratio between the first gear and the second gear is set to 1.

In the webbing take-up device of the seventh aspect of the present invention, the gear ratio between the first gear and the second gear is set to 1. This thereby enables a rotation angle of the first gear and a rotation angle of the second gear to be the same, facilitating design of the second gear.

A webbing take-up device of the eighth aspect of the present invention is the webbing take-up device of any one of the first aspect to the seventh aspect of the present invention, wherein the first gear and the second gear are configured from resin.

In the webbing take-up device of the eighth aspect of the present invention, the first gear and the second gear are configured from resin. This thereby enables the first gear and the second gear to be manufactured easily.

A webbing take-up device of a ninth aspect of the present invention is the webbing take-up device of any one of the first aspect to the eighth aspect of the present invention, further including a gear shaft integrally molded with the second gear.

In the webbing take-up device of the ninth aspect of the present invention, the gear shaft is integrally molded with the second gear. This thereby enables the gear shaft to be manufactured easily.

A webbing take-up device of a tenth aspect of the present invention is the webbing take-up device of any one of the first aspect to the ninth aspect of the present invention, further including an urging member that is coupled to the second gear, and that is configured so as to urge the spool in the take-up direction via the second gear and the first gear.

In the webbing take-up device of the tenth aspect of the present invention, the urging member is coupled to the second gear, and the urging member urges the spool in the take-up direction via the second gear and the first gear. This thereby enables urging force to be caused to act on the webbing in the spool take-up direction.

The webbing take-up device of the eleventh aspect of the present invention is the webbing take-up device of the tenth aspect of the present invention, further including a support body that is configured to rotatably support the spool, the urging member being arranged at an inner side of the support body.

In the webbing take-up device of the eleventh aspect of the present invention, the support body rotatably supports the spool.

The urging member is arranged at the inner side of the support body. This thereby enables the webbing take-up device to be made more compact in the axial direction of the spool in contrast to cases in which the urging member is arranged at the outer side of the support body.

A webbing take-up device of the twelfth aspect of the present invention is the webbing take-up device of an eleventh aspect of the present invention, wherein the urging member is arranged at a support body inner side of the second gear.

In the webbing take-up device of the twelfth aspect of the present invention, the urging member is arranged at the support body inner side of the second gear. This thereby enables the urging member to be easily coupled to the second gear.

A webbing take-up device of a thirteenth aspect of the present invention is the webbing take-up device of any one of the first aspect to the twelfth aspect of the present invention, wherein the second gear is urged toward a side at which the second gear is coupled to the first gear.

In the webbing take-up device of the thirteenth aspect of the present invention, the second gear is urged toward the side at which the second gear is coupled to the first gear. This thereby enables the second gear to be appropriately coupled to the first gear.

A webbing take-up device of a fourteenth aspect of the present invention is the webbing take-up device of the thirteenth aspect of the present invention, wherein a shaft bearing hole of the second gear is extended at the side at which the second gear is coupled to the first gear.

In the webbing take-up device of a fourteenth aspect of the present invention, the shaft bearing hole of the second gear is extended at the side at which the second gear is coupled to the first gear. This thereby enables the second gear to be easily displaced at the side of coupling to the first gear.

A webbing take-up device of a fifteenth aspect of the present invention is the webbing take-up device of any one of the first aspect to the fourteenth aspect of the present invention, further including a support member that is configured so as to rotatably support the second gear.

In the webbing take-up device of the fifteenth aspect of the present invention, the support member rotatably supports the second gear. This thereby enables the second gear to be appropriately supported.

A webbing take-up device of a sixteenth aspect of the present invention is the webbing take-up device of the fifteenth aspect of the present invention, further including an engaging member that is configured to engage with the support member, the second gear being arranged between the support member and the engaging member.

In the webbing take-up device of the sixteenth aspect of the present invention, the engaging member is engaged with the support member, and the second gear is arranged between the support member and the engaging member. This thereby enables the second gear to be appropriately placed.

A webbing take-up device of a seventeenth aspect of the present invention is the webbing take-up device of the sixteenth aspect of the present invention, further including a support body that is configured by a support plate being attached to a support main body, and that rotatably supports the spool, the support member or the engaging member being attached to the support plate.

In the webbing take-up device of the seventeenth aspect of the present invention, the support body rotatably supports the spool. The support body is configured by the support plate being attached to the support main body.

The support member or the engaging member is attached to the support plate. This thereby enables easy assembly of the support member, the engaging member, and the second gear.

### BRIEF DESCRIPTION OF THE DRAWINGS

Exemplary embodiments of the present invention will be described in detail based on the following figures, wherein:

FIG. 1 is an exploded perspective view illustrating a webbing take-up device according to a first exemplary embodiment of the present invention, as viewed diagonally from the left rear;

FIG. 2A is a perspective view illustrating a webbing take-up device according to the first exemplary embodiment of the present invention, as viewed diagonally from the left rear; FIG. 2B is a perspective view illustrating a webbing take-up device according to the first exemplary embodiment of the present invention, as viewed diagonally from the front right;

FIG. 3 is a cross-section illustrating a webbing take-up device according to the first exemplary embodiment of the present invention, as viewed from the front;

FIG. 4A is a face-on view illustrating a gear sensor and the like of a webbing take-up device according to the first exemplary embodiment of the present invention, as viewed from the left;

FIG. 4B is a face-on view illustrating a V-gear and the like of a webbing take-up device according to the first exemplary embodiment of the present invention, as viewed from the left;

FIG. 5A is a perspective view illustrating main elements of a webbing take-up device according to the first exemplary embodiment of the present invention, as viewed diagonally from the front right;

FIG. 5B is a perspective view illustrating main elements of a webbing take-up device according to the first exemplary embodiment of the present invention, as viewed diagonally from the rear right;

FIG. 6A is a perspective view illustrating a shaft gear and the like of a webbing take-up device according to the first exemplary embodiment of the present invention, as viewed diagonally from the rear left;

FIG. 6B is a perspective view illustrating a shaft gear and the like of a webbing take-up device according to the first exemplary embodiment of the present invention as viewed diagonally from the rear right;

FIG. 7A is a perspective view illustrating a gear sensor and the like of a webbing take-up device according to the first exemplary embodiment of the present invention, as viewed diagonally from the rear left;

FIG. 7B is a perspective view illustrating a gear sensor and the like of a webbing take-up device according to the first exemplary embodiment of the present invention, as viewed diagonally from the rear right;

FIG. 8A is a side view illustrating a V-sensor and the like of a webbing take-up device according to the first exemplary embodiment of the present invention, as viewed from the front;

FIG. 8B is a side view illustrating a gear sensor and the like of a webbing take-up device according to the first exemplary embodiment of the present invention, as viewed from the front;

FIG. 9A is a front view illustrating an outline of a webbing take-up device according to the first exemplary embodiment of the present invention, as viewed from the front;

FIG. 9B is a face-on view illustrating a modified example of a plate in a webbing take-up device according to the first exemplary embodiment of the present invention, as viewed from the left;

FIG. 10 is a front view illustrating an outline of a webbing take-up device according to a second exemplary embodiment of the present invention, as viewed from the front;

FIG. 11A is a front view illustrating an outline of a webbing take-up device according to a third exemplary embodiment of the present invention, as viewed from the front; and

FIG. 11B is a face-on view illustrating main elements of a webbing take-up device according to a fourth exemplary embodiment of the present invention, as viewed from the right.

### DETAILED DESCRIPTION

### First Exemplary Embodiment

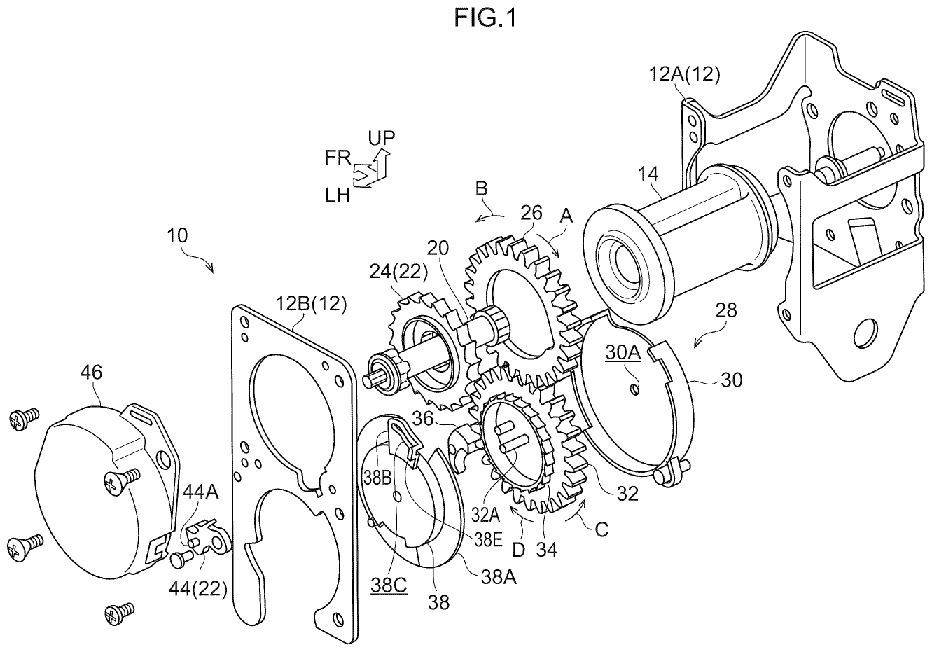

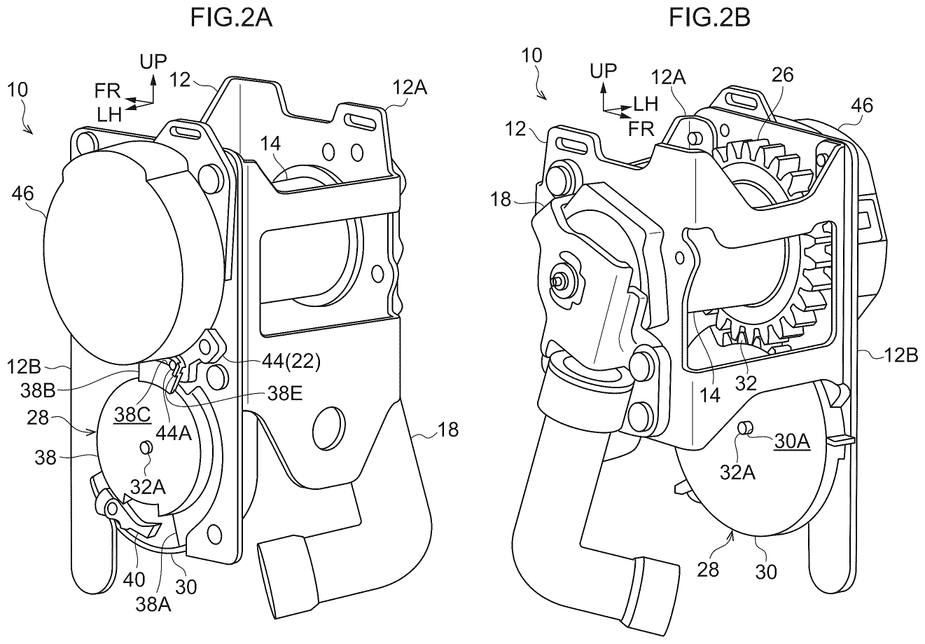

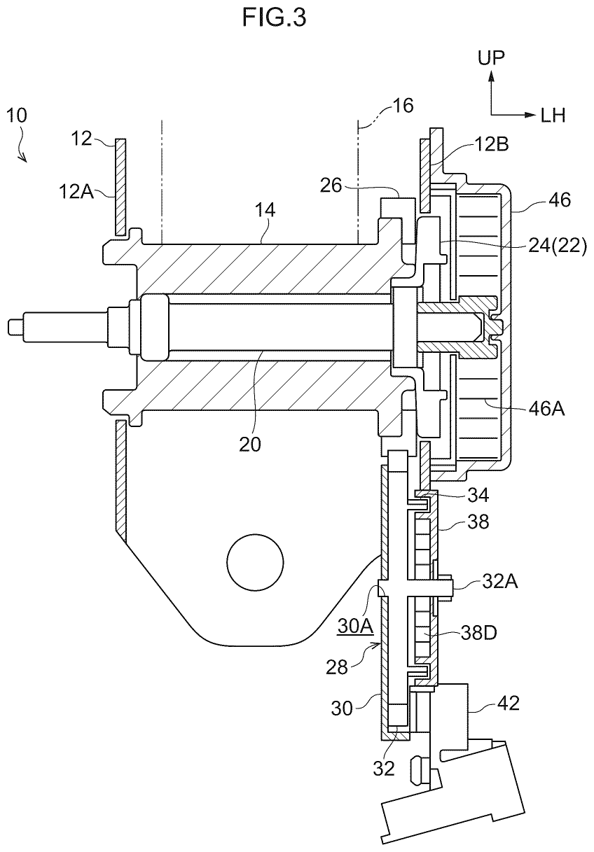

FIG. 1 is an exploded perspective view illustrating a webbing take-up device 10 according to a first exemplary embodiment of the present invention, as viewed diagonally from the rear left. Moreover, FIG. 2A is a perspective view illustrating the webbing take-up device 10, as viewed diagonally from the left rear, and FIG. 2B is a perspective view illustrating the webbing take-up device 10, as viewed diagonally from the front right. Furthermore, FIG. 3 is a cross-section illustrating the webbing take-up device 10 as viewed from the front. Note that in these drawings, the front of the webbing take-up device 10 is indicated by arrow FR, the left of the webbing take-up device 10 is indicated by arrow LH, and upward for the webbing take-up device 10 is indicate by arrow UP.

The webbing take-up device 10 according to the present exemplary embodiment is installed inside a seatback of a seat of a vehicle, and a front, left, and upward of the webbing take-up device 10 respectively indicate directions toward the front side, left side, and upward for the vehicle.

As illustrated in FIG. 1, FIG. 2A, FIG. 2B, and FIG. 3, a metal frame 12 having a tubular shape with a substantially rectangular cross-section and serving as a support body is provided to the webbing take-up device 10. The frame 12 is configured by a substantially rectangular plate-shaped plate 12B being joined to a frame main body 12A that has a plate shape with a substantially U-shaped cross-section, with the frame main body 12A configuring a front wall, a rear wall, and a right wall of the frame 12, and the plate 12B configuring a left wall of the frame 12. The frame 12 has a rear wall fixed to a seatback inside, with the webbing take-up device 10 thereby being installed inside the seatback.

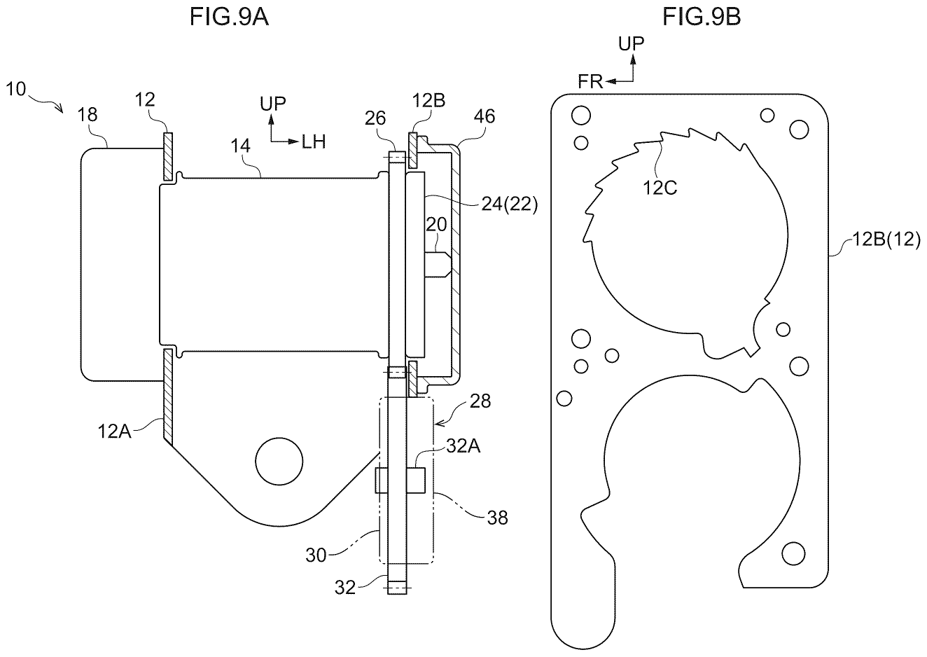

A substantially circular tube-shaped spool 14 (see FIG. 9A) is rotatably supported between the left wall and the right wall of the metal frame 12, with a left end portion of the spool 14 passing through the left wall of the frame 12 so as to be able to rotate.

An elongated belt-shaped webbing 16 is taken up on the spool 14 from a length direction base end side of the webbing 16, with the webbing 16 being taken up on the spool 14 by the spool 14 being rotated in a take-up direction A (see FIG. 1), and also the spool 14 being rotated in a pull-out direction B (see FIG. 1) by the webbing 16 being pulled out from the spool 14. The webbing 16 is pulled out from the spool 14 and extended to outside the seatback, and the webbing 16 is fitted over an occupant seated on the seat.

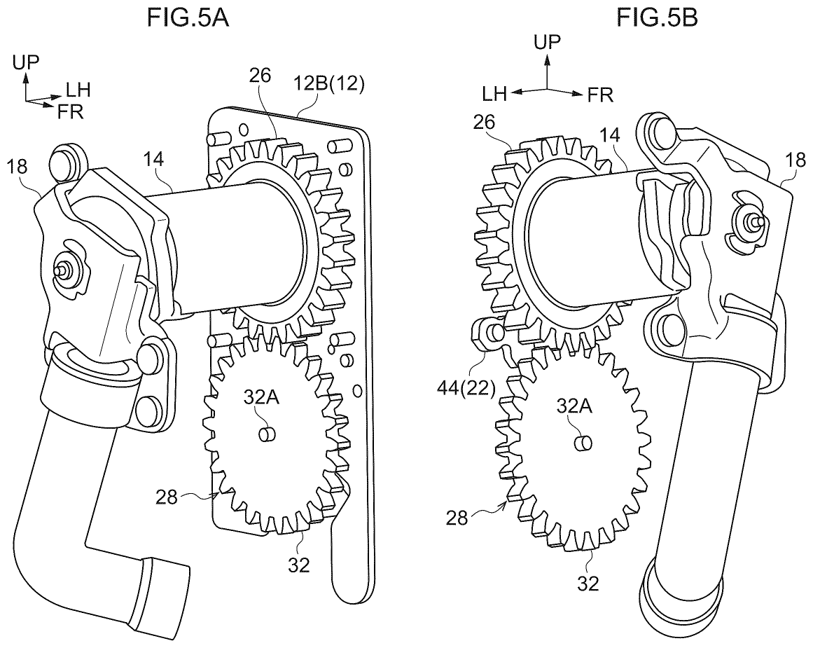

A pre-tensioner mechanism 18 (see FIG. 5A and FIG. 5B) is fixed to a right side of the metal frame 12, with the pre-tensioner mechanism 18 generating gas at high pressure instantaneously during a vehicle collision (in an emergency), and the spool 14 being rotated in the take-up direction A by pressure of this gas, and the webbing 16 being taken up on the spool 14.

A metal torsion shaft 20 having a substantially circular pillar shape is arranged as an energy absorption member coaxially inside the spool 14, with a right end portion of the torsion shaft 20 being coupled to a right end portion of the inside of the spool 14 so as to be capable of rotating as a single body therewith.

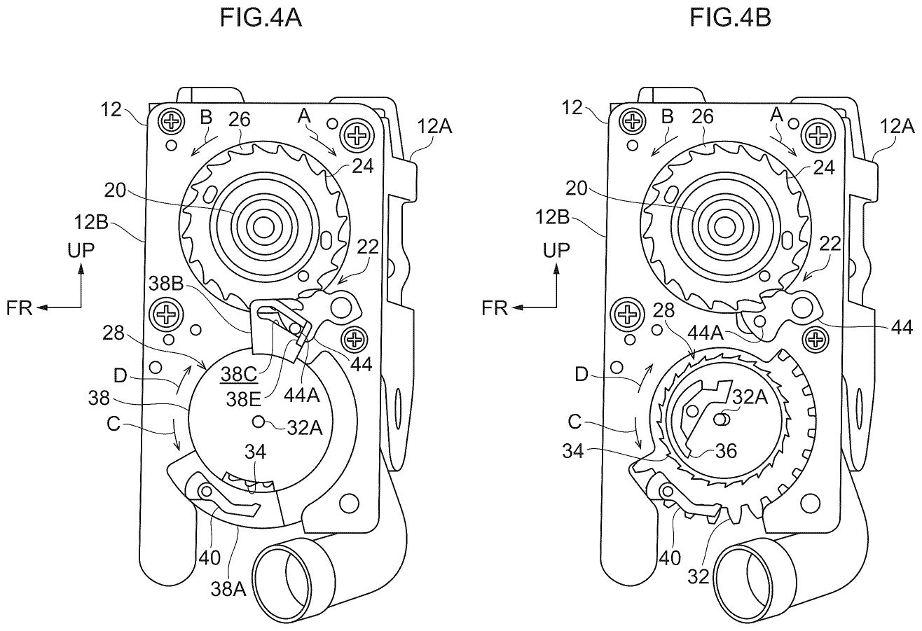

A left end portion of the torsion shaft 20 passes coaxially through a metal lock gear 24 (see FIG. 4A and FIG. 4B) having a substantially circular plate shape and serving as a locked-onto member configuring a lock mechanism 22, with the lock gear 24 being coupled to a left end portion of the torsion shaft 20 so as to be capable of rotating as a single body therewith, and passing through a left wall (the plate 12B) of the frame 12 so as to be capable of rotating. The lock gear 24 is configured by a ratchet gear, and ratchet teeth are formed around the entire outer periphery of the lock gear 24. Moreover, a left end of the torsion shaft 20 projects out to the left of the lock gear 24.

A resin shaft gear 26 (see FIG. 5A and FIG. 5B) having a substantially circular plate shape and serving as a first gear is arranged coaxially at a right side of the lock gear 24, with the shaft gear 26 joined to the lock gear 24 so as to be capable of rotating as a single body therewith, and also so as to be adjacent at the right side of the left wall of the metal frame 12.

A sensor mechanism 28 serving as an actuation mechanism is provided at a lower side of the lock gear 24 and the shaft gear 26.

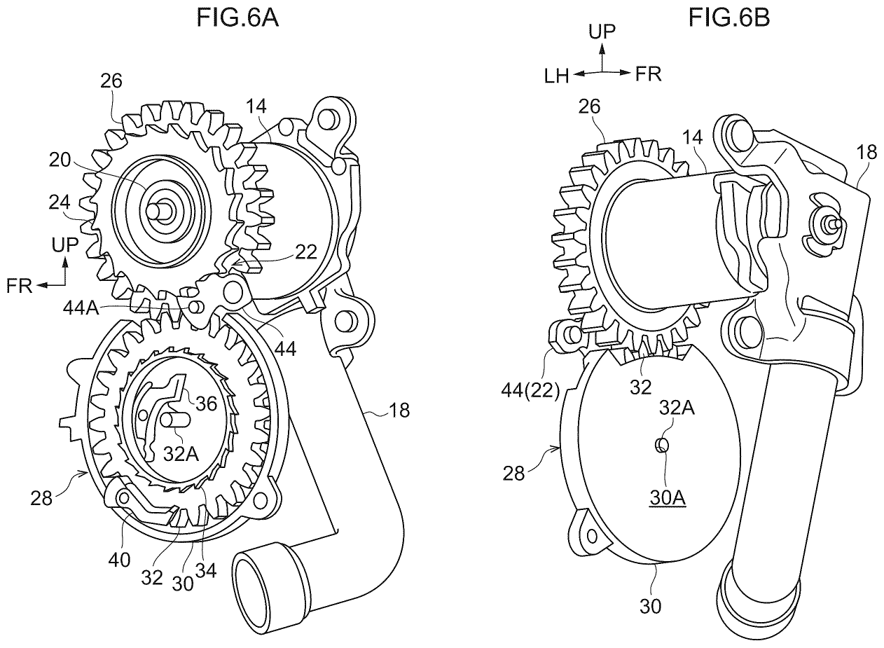

A resin sensor case 30 (see FIG. 6A and FIG. 6B) having a substantially circular bottomed-cylinder shape and serving as a support member is provided to the sensor mechanism 28, with the sensor case 30 attached at the right side of the left wall of the frame 12 (the plate 12B). The inside of the sensor case 30 is open to the left, with a circular-shaped shaft bearing hole 30A formed piercing through a center of the bottom wall (right wall) of the sensor case 30.

A resin transmission gear 32 (see FIG. 5A, FIG. 5B, and FIG. 6A) having a substantially circular plate shape and serving as a second gear is coaxially housed in the sensor case 30, with the transmission gear 32 arranged with its axial direction parallel to the axial direction (left-right direction) of the shaft gear 26, and also with a center axis line arranged below the center axis line of the shaft gear 26. A circular pillar-shaped gear shaft 32A is integrally formed coaxially to the transmission gear 32, with the gear shaft 32A extended to the left and right of the transmission gear 32. A right end portion of the gear shaft 32A is fitted together with a shaft bearing hole 30A of the sensor case 30, with the transmission gear 32 rotatably supported by the sensor case 30. An upper portion of the transmission gear 32 is exposed to the upper side of the sensor case 30, and is meshed (coupled) to a lower portion of the shaft gear 26, with the transmission gear 32 being rotated in a first direction C (see FIG. 1) when the shaft gear 26 is rotated in the take-up direction A, and the transmission gear 32 being rotated in a second direction D (see FIG. 1) when the shaft gear 26 is rotated in the pull-out direction B. A radius of the transmission gear 32 is configured the same as the radius of the shaft gear 26, with a gear ratio between the transmission gear 32 and the shaft gear 26 set at 1.

A resin V-gear 34 having a bottomed substantially circular cylindrical shape and serving as an actuation member is integrally formed coaxially at the left side of the transmission gear 32, with a bottom wall (right wall) of the V-gear 34 configuring the transmission gear 32, and the inside of the V-gear 34 open toward the left side. The V-gear 34 is configured by a ratchet gear, and ratchet teeth are formed around the entire outer periphery of the V-gear 34. A metal or resin W-pawl 36 having an elongated plate shape is supported at the bottom face (right face) inside the V-gear 34, with the W-pawl 36 being able to swing within a specific range, with the swing center axis at a position displaced from the gear shaft 32A. The W-pawl 36 is urged, with the W-pawl 36 being able to swing against urging force.

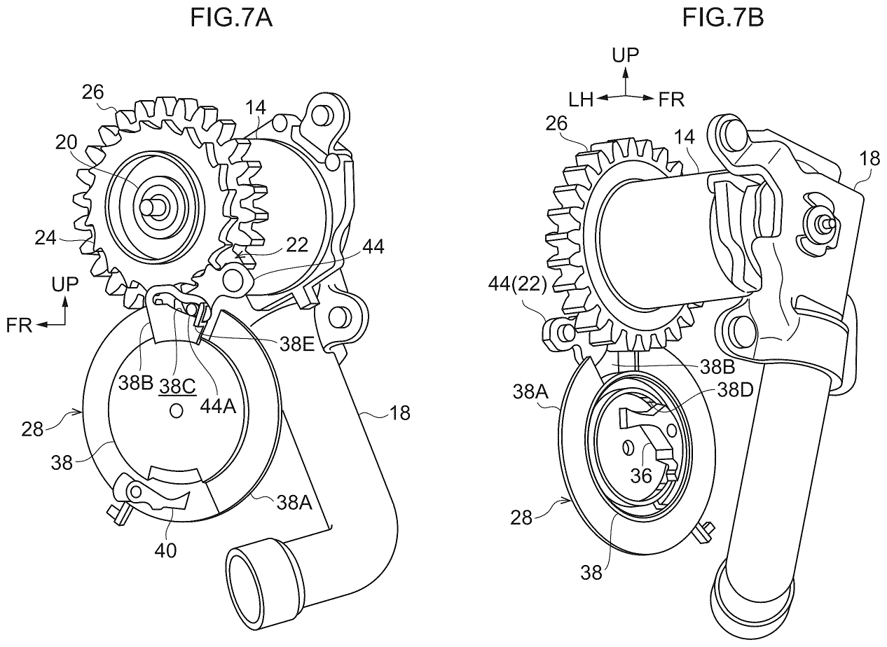

A resin gear sensor 38 (see FIG. 4A, FIG. 7A, and FIG. 7B) having a bottomed substantially circular cylindrical shape and serving as an engaging member is arranged coaxially at a left side of the V-gear 34, with the gear sensor 38 having an inside open toward the right, and also passing through a left wall of the frame 12 (the plate 12B). A substantially circular plate-shaped engagement plate 38A is integrally formed coaxially to a right end portion of the outer periphery of the gear sensor 38, with the engagement plate 38A rotatably fitted inside the sensor case 30. The engagement plate 38A is engaged with the sensor case 30, and detachment of the engagement plate 38A from the sensor case 30 is restricted. The V-gear 34 is inserted coaxially inside the gear sensor 38 and also the left end portion of the gear shaft 32A of the transmission gear 32 and the V-gear 34 pass through the bottom wall (left wall) of the gear sensor 38, with the transmission gear 32 and the V-gear 34 being rotatably supported by the gear sensor 38.

A substantially rectangular plate-shaped actuation plate 38B is integrally formed at the left side of an upper portion of the gear sensor 38, with the actuation plate 38B projecting upward. An elongated actuation hole 38C is formed piercing through the actuation plate 38B, and the actuation hole 38C is open in the second direction D, and is inclined in a direction upward (toward the lock gear 24 side) on progression along the first direction C. A substantially rectangular plate shape coupling plate 38E is integrally formed to the actuation plate 38B, with the coupling plate 38E being coupled at an upper side portion and a lower side portion at the second direction D side end portion of the actuation hole 38C of the actuation plate 38B.

A substantially circular cylindrical-shaped internal-tooth ratchet 38D (see FIG. 7B) is integrally formed coaxially to a bottom face (left face) at the inside of the gear sensor 38, with ratchet teeth formed around the entire inner periphery of the internal-tooth ratchet 38D. The internal-tooth ratchet 38D is inserted coaxially inside the V-gear 34, and the W-pawl 36 is arranged at the inside of the internal-tooth ratchet 38D. When the W-pawl 36 has swung against urging force, the W-pawl 36 meshes with the ratchet teeth of the internal-tooth ratchet 38D, the gear sensor 38 is rotated in the second direction D by rotation of the V-gear 34 in the second direction D, but is not rotated in the first direction C by rotation of the V-gear 34 in the first direction C.

A resin V-pawl 40 (see FIG. 7A) having an elongated plate shape is supported at a left side of a lower portion of the engagement plate 38A, with the V-pawl 40 being able to pivot in the up-down direction. A lower portion of the V-gear 34 is exposed at the lower side of the gear sensor 38, with the V-pawl 40 being able to mesh with the ratchet teeth of the V-gear 34 when pivoted upward.

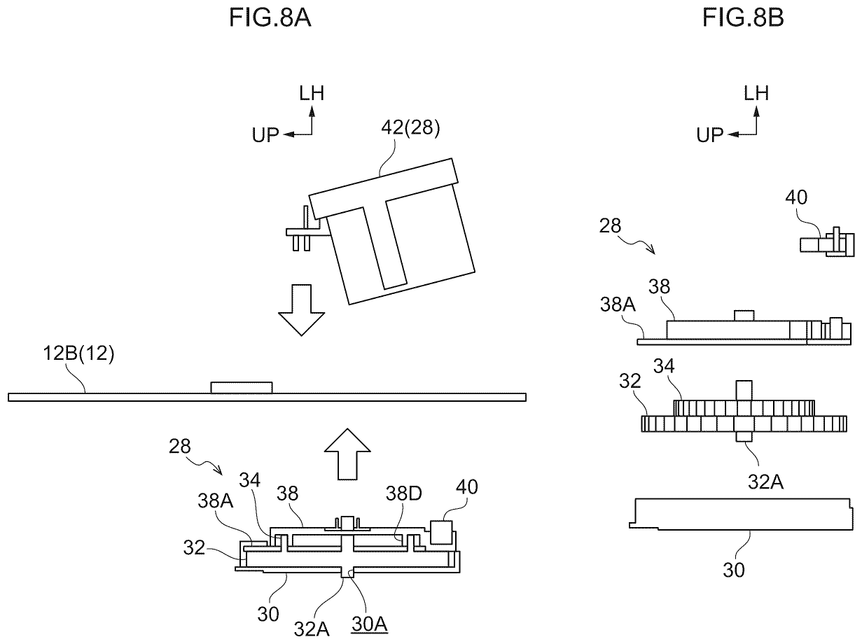

At a left side of the left wall of the frame 12 (the plate 12B), a V sensor 42 (see FIG. 8A) is attached at a lower side of the V-pawl 40, with the V sensor 42 being either a mechanical or electronic type of sensor for detecting vehicle acceleration and vehicle tilt. When the V sensor 42 has detected a sudden vehicle deceleration or a vehicle tilt during a vehicle collision, the V sensor 42 is actuated and pivots the V-pawl 40 upward. The V-pawl 40 is accordingly meshed with the ratchet teeth of the V-gear 34, and the gear sensor 38 is able to rotate in the second direction D by rotation of the V-gear 34 in the second direction D, and is not able to rotate in the first direction C by rotation of the V-gear 34 in the first direction C.

At a left side of a left wall of the frame 12 (the plate 12B), a metal lock plate 44 (see FIG. 4A, FIG. 4B, and FIG. 7A), having an elongated plate shape and configuring the lock mechanism 22, is supported at a lower side of the lock gear 24, with the lock plate 44 able to pivot in the up-down direction. A circular pillar-shaped actuation pin 44A is integrally provided at a distal end portion of the lock plate 44, with the actuation pin 44A projecting leftward. The actuation pin 44A is inserted into the actuation hole 38C of the actuation plate 38B of the gear sensor 38 through an open portion toward the second direction D of the actuation hole 38C, with the actuation pin 44A arranged at a portion on the second direction D side of the actuation hole 38C. When the gear sensor 38 has been rotated in the second direction D, the actuation pin 44A is moved to the first direction C side of the actuation hole 38C, and the lock plate 44 is pivoted upward thereby. This means that the lock plate 44 is meshed with the ratchet teeth of the lock gear 24, rotation of the lock gear 24 in the pull-out direction B is locked, and rotation of the lock gear 24 in the take-up direction A is permitted.

At the left wall of the frame 12 (the plate 12B), a substantially circular pillar-shaped spring mechanism 46 serving as an urging mechanism is attached to the left side of the lock gear 24, with a spring 46A (flat spiral spring) serving as an urging member provided inside the spring mechanism 46. The spring 46A is coupled to the torsion shaft 20, with the spring 46A urging the spool 14 in the take-up direction A via the torsion shaft 20.

Next, description follows regarding operation of the present exemplary embodiment.

In the webbing take-up device 10 configured as described above, the webbing 16 is pulled out from the spool 14, and the webbing 16 is fitted over an occupant seated on the seat. The spool 14 is rotated in the take-up direction by urging force of the spring 46A of the spring mechanism 46, with slack in the webbing 16 fitted over the occupant being removed by the webbing 16 being taken up on the spool 14.

During a vehicle collision, when the webbing 16 is suddenly pulled out from the spool 14 by the occupant moving under inertia and the V-gear 34 has been suddenly rotated in the second direction D via the torsion shaft 20, the shaft gear 26 and the transmission gear 32, the W-pawl 36 inside the V-gear 34 is swung by inertial force and centrifugal force against the urging force, such that the W-pawl 36 meshes (couples) with the ratchet teeth of the internal-tooth ratchet 38D of the gear sensor 38, and the gear sensor 38 is rotated in the second direction D by rotation of the V-gear 34 in the second direction D.

Moreover, when the V sensor 42 has detected sudden vehicle deceleration during a vehicle collision, the V sensor 42 pivots the V-pawl 40 of the gear sensor 38 upward, the V-pawl 40 meshes (couples) with the ratchet teeth of the V-gear 34, and the gear sensor 38 is rotated in the second direction D by rotation of the V-gear 34 in the second direction D.

As described above, when the gear sensor 38 has been rotated in the second direction D, the actuation pin 44A of the lock plate 44 is moved to the first direction C side of the actuation hole 38C of the gear sensor 38 (the actuation plate 38B), and due to the lock plate 44 being pivoted upward, the lock plate 44 is meshed with the ratchet teeth of the lock gear 24 (the lock mechanism 22 is actuated), and rotation of the lock gear 24 in the pull-out direction B is locked. This means that rotation of the spool 14 in the pull-out direction B is also locked via the torsion shaft 20, and the occupant is restrained by the webbing 16 due to pull-out of the webbing 16 from the spool 14 being restricted.

The transmission gear 32 of the sensor mechanism 28 is meshed (coupled) to the shaft gear 26 that is on the same shaft as the spool 14, the rotation of the shaft gear 26 is transmitted to the transmission gear 32, and the transmission gear 32 is rotated. This means that, in contrast to cases in which the shaft gear 26 and the transmission gear 32 are arranged coaxially, the webbing take-up device 10 can be made more compact in the axial direction (left-right direction) of the spool 14.

Furthermore, lock gear 24 that is on the same shaft as the spool 14 passes through the left wall of the frame 12. This means that, in contrast to cases in which the lock gear 24 is arranged entirely at outside of the left wall of the frame 12, the webbing take-up device 10 can be made more compact in the axial direction of the spool 14.

Moreover, the shaft gear 26 on the same shaft as the spool 14 is adjacent at the left wall inside of the frame 12. This means that the left wall of the frame 12 can be brought in proximity to the shaft gear 26, enabling the webbing take-up device 10 to be more compact in the axial direction of the spool 14.

Moreover, the lock gear 24 is made from metal (and particularly from a hard steel). This means that movement in the radial direction of the lock gear 24 and the spool 14 can be effectively restricted by the lock gear 24 being abutted against a peripheral face of a through hole for the lock gear 24 formed in the left wall of the frame 12.

Furthermore, ratchet teeth are formed to the lock gear 24. This means that there is no need to form ratchet teeth to the peripheral face of the through hole for the lock gear 24 formed in the left wall of the frame 12, enabling a high strength for the left wall of the frame 12.

Moreover, during a vehicle collision, the metal lock plate 44 is meshed with the metal lock gear 24 and rotation of the spool 14 is locked, and so the load from the webbing 16 restraining the occupant acts on the lock plate 44 and the lock gear 24, and does not act on the shaft gear 26, the transmission gear 32, the V-gear 34, the sensor case 30, and the gear sensor 38. This means that the strength of the shaft gear 26, the transmission gear 32, the V-gear 34, the sensor case 30, and the gear sensor 38, which are not on the load transmission path from the spool 14 to the lock plate 44, can be lowered, and the shaft gear 26, the transmission gear 32, the V-gear 34, the sensor case 30, and the gear sensor 38 can be configured from resin. This thereby enables easy manufacture of the shaft gear 26, the transmission gear 32, the V-gear 34, the sensor case 30, and the gear sensor 38 and also enables a weight saving to be achieved.

Furthermore, the V-gear 34 is configured as a single body with the transmission gear 32. This enables a simpler configuration in contrast to cases in which the V-gear 34 is configured by a separate body to the transmission gear 32.

Moreover, the gear shaft 32A of the transmission gear 32 and the V-gear 34 is molded as a single body to the transmission gear 32. This enables easy manufacture of the gear shaft 32A and also enables a high accuracy to be achieved in dimensions and position of the gear shaft 32A.

Furthermore, the gear ratio between the transmission gear 32 and the shaft gear 26 is set as 1. This means that the rotation angle of the shaft gear 26 and the rotation angle of the transmission gear 32 and the V-gear 34 can be the same, facilitating design of the transmission gear 32 and the V-gear 34.

Moreover, in the sensor mechanism 28, the engagement plate 38A of the gear sensor 38 is engaged with the sensor case 30, and the transmission gear 32 and the V-gear 34 are rotatably supported between the sensor case 30 and the gear sensor 38. This accordingly enables the transmission gear 32 and the V-gear 34 to be appropriately supported and also appropriately placed. Moreover, the gear shaft 32A of the transmission gear 32 and the V-gear 34 can be shortened, enabling a more compact configuration.

Moreover, the frame 12 is configured by the plate 12B being attached to the frame main body 12A, and with a unit (see FIG. 8B) of the sensor case 30, the transmission gear 32, the V-gear 34 (including the W-pawl 36), and the gear sensor 38 (including the V-pawl 40) in the sensor mechanism 28, and the V sensor 42 (see FIG. 8A), being assembled to the plate 12B. This means that due to the plate 12B being attached to the frame main body 12A after the sensor mechanism 28 has been assembled to the plate 12B, the sensor mechanism 28 can be assembled easily.

Note that in the present exemplary embodiment the shaft gear 26 may be configured by a shaft having a high strength made from a hard resin or a metal. In such cases, the shaft gear 26 and the spool 14 can be effectively restricted from moving toward the left by the shaft gear 26 being abutted against the left wall of the frame 12.

Moreover, in the present exemplary embodiment, as illustrated in FIG. 9B, plural ratchet teeth 12C (internal teeth) serving as a lock section may be formed successively to an upper side portion (pull-out side of the webbing 16 from the spool 14) of the through hole of the lock gear 24 at the left wall of the frame 12 (the plate 12B). In such cases, the spool 14 and the lock gear 24 are moved upward by force of the webbing 16 being pulled out from the spool 14 by the occupant during a vehicle collision, and due to the ratchet teeth of the lock gear 24 meshing (engaging) with the ratchet teeth 12C of the left wall of the frame 12, rotation of the ratchet teeth 12C in the pull-out direction B of the lock gear 24 is locked (rotation of the lock gear 24 in the take-up direction A is permitted), and rotation of the spool 14 in the pull-out direction B is locked via the torsion shaft 20. This thereby enables rotation of the spool 14 in the pull-out direction to be locked effectively.

### Second Exemplary Embodiment

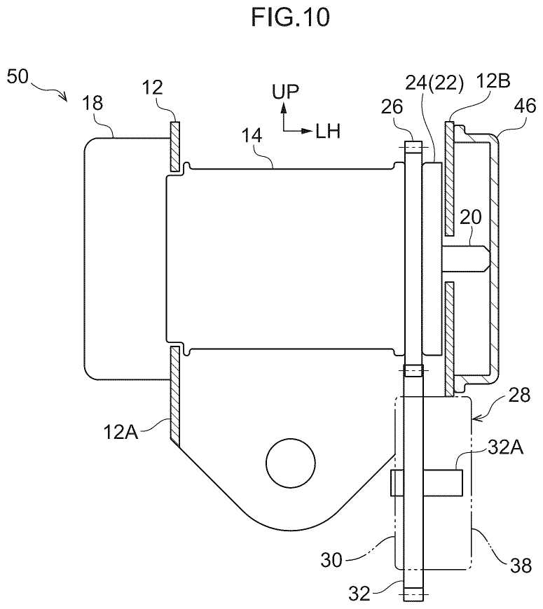

FIG. 10 is a side view illustrating an outline of a webbing take-up device 50 according to a second exemplary embodiment of the present invention, as viewed from the front.

The webbing take-up device 50 according to the present exemplary embodiment is configured substantially the same as the first exemplary embodiment, but differs in the following points.

As illustrated in FIG. 10, in the webbing take-up device 50 according to the present exemplary embodiment, a left end of a torsion shaft 20 passes through a left wall of a frame 12 (plate 12B) so as to be rotatable, and a lock gear 24 of a lock mechanism 22 does not pass through the left wall of the frame 12. The lock gear 24 is adjacent at the right side of the left wall of the frame 12, and the shaft gear 26 is not adjacent to the left wall of the frame 12.

Similar operation and advantageous effects to those of the first exemplary embodiment can be exhibited in the present exemplary embodiment too, except for the operation and advantageous effects that were due to the lock gear 24 being passed through the left wall of the frame 12 and the shaft gear 26 being adjacent to the left wall of the frame 12.

Furthermore, the lock gear 24 is made from a metal (in particular from a steel), and is adjacent at the right side of the left wall of the frame 12. This means that movement of the lock gear 24 and the spool 14 toward the left can be effectively restricted by the lock gear 24 being abutted against the left wall of the frame 12.

### Third Exemplary Embodiment

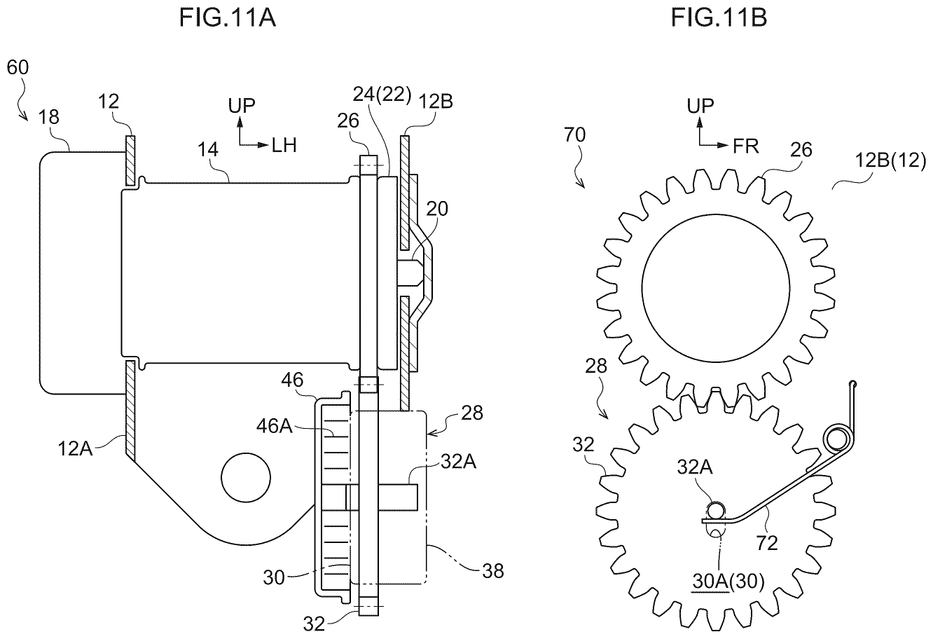

FIG. 11A is a front view illustrating an outline of webbing take-up device 60 according to a third exemplary embodiment of the present invention, as viewed from the front.

The webbing take-up device 60 according to the present exemplary embodiment is a configuration substantially the same as that of the second exemplary embodiment, but differs in the following points.

As illustrated in FIG. 11A, in the webbing take-up device 60 according to the present exemplary embodiment, a spring mechanism 46 is attached to the right side of a sensor case 30 of a sensor mechanism 28, and the spring mechanism 46 is arranged inside the frame 12. A spring 46A inside the spring mechanism 46 is coupled to a gear shaft 32A of a transmission gear 32 and a V-gear 34, with the spring 46A urging the transmission gear 32 in a first direction C, and urging the spool 14 in a take-up direction A via a shaft gear 26, a lock gear 24, and a torsion shaft 20. This means that urging force acts on webbing 16 in a spool 14 take-up direction.

Similar operation and advantageous effects to those of the second exemplary embodiment can be exhibited by the present exemplary embodiment too.

Furthermore, the spring mechanism 46 is arranged at the inside of the frame 12. This means that, in contrast to cases in which the spring mechanism 46 is arranged at the outside of the frame 12, the webbing take-up device 60 can be configured more compact in the axial direction of the spool 14.

Moreover, the spring mechanism 46 is arranged at the inside of the frame 12 for the transmission gear 32 and the V-gear 34. This means that the spring 46A of the spring mechanism 46 is easily coupled to the transmission gear 32 and the V-gear 34.

### Fourth Exemplary Embodiment

FIG. 11B is a face-on view illustrating main elements of a webbing take-up device 70 according to a fourth exemplary embodiment of the present invention, as viewed from the right.

The webbing take-up device 70 according to the present exemplary embodiment is configured substantially the same as the second exemplary embodiment, but differs in the following points.

As illustrated in FIG. 11B, in the webbing take-up device 70 according to the present exemplary embodiment, in a sensor mechanism 28, a shaft bearing hole 30A of a sensor case 30 extends downward, and a right end portion of a gear shaft 32A of a transmission gear 32 and a V-gear 34 is able to displace (pivot) in the up-down direction along the shaft bearing hole 30A.

A central portion (coil portion) of a torsion coil spring 72 serving as an additional urging member is supported by a right face of a left wall of a frame 12 (plate 12B), with a one-end portion of the torsion coil spring 72 fixed to the left wall of the frame 12. The other-end side portion of the torsion coil spring 72 is passed through a peripheral wall of the sensor case 30 so as to be moveable, and the other-end portion of the torsion coil spring 72 is abutted against a right portion of the gear shaft 32A from below. The gear shaft 32A is accordingly urged upward by the torsion coil spring 72 (a direction of a center axis line of the gear shaft 32A toward a center axis line of a shaft gear 26), and is abutted against an upper face of a shaft bearing hole 30A, with the axial direction of the transmission gear 32 and the V-gear 34 arranged parallel to the axial direction of the shaft gear 26.

Similar operation and advantageous effects to those of the second exemplary embodiment can be exhibited by the present exemplary embodiment too.

Furthermore, the shaft bearing hole 30A of the sensor case 30 is extended in the up-down direction (toward a meshing side of the transmission gear 32 with the shaft gear 26). This means that the gear shaft 32A of the transmission gear 32 can be readily displaced in the up-down direction, and the transmission gear 32 can be readily displaced in the up-down direction.

Moreover, the transmission gear 32 is urged by the torsion coil spring 72 toward the upper side (meshing side with the shaft gear 26). This accordingly enables the transmission gear 32 to be appropriately meshed with the shaft gear 26. Rattling (backlash) between the shaft gear 26 and the transmission gear 32 can accordingly be suppressed, enabling abnormal noises to be suppressed from being generated between the shaft gear 26 and the transmission gear 32, and also enabling rotation transmission loss to be suppressed from being generated between the shaft gear 26 and the transmission gear 32.

Note that the third exemplary embodiment and the fourth exemplary embodiment are applied to the second exemplary embodiment. However, the third exemplary embodiment and the fourth exemplary embodiment may also be applied to the first exemplary embodiment.

Moreover, in the first exemplary embodiment to the fourth exemplary embodiment, the shaft gear 26 and the transmission gear 32 are coupled by being meshed together. However, the shaft gear 26 and the transmission gear 32 may be coupled together through a specific number of intermediate gears.

What is claimed is:

1. A webbing take-up device comprising:
a spool that is configured to take up webbing fitted over an occupant by being rotated in a take-up direction, and to be rotated in a pull-out direction by the webbing being pulled out;
a first gear that is configured to be rotated as a single body with the spool;
a lock mechanism that is configured to lock rotation of the spool in the pull-out direction when actuated;
an actuation mechanism that is configured so as to actuate the lock mechanism; and
a second gear that is provided at the actuation mechanism, and that is coupled to the first gear and rotated by transmission of rotation of the first gear.

2. The webbing take-up device of claim 1, further comprising an actuation member that is provided at the actuation mechanism, and that is configured as a single body with the second gear, the lock mechanism being actuated when the actuation member is rotated while in a state of being coupled to the lock mechanism.

3. The webbing take-up device of claim 1, further comprising a locked-onto member that is provided at the lock mechanism, and that is rotated as a single body together with the spool, rotation of the locked-onto member in the pull-out direction being locked by actuation of the lock mechanism.

4. The webbing take-up device of claim 3, further comprising a support body that rotatably supports the spool, the locked-onto member passing through a wall of the support body.

5. The webbing take-up device of claim 4, further comprising a lock section that is provided at the support body at a webbing pull-out side of the locked-onto member, and that is configured to lock rotation of the locked-onto member in the pull-out direction when engaged with the locked-onto member.

6. The webbing take-up device of claim 1, further comprising a support body that rotatably supports the spool, the first gear being adjacent at an inner side of the support body.

7. The webbing take-up device of claim 1, wherein a gear ratio between the first gear and the second gear is set to 1.

8. The webbing take-up device of claim 1, wherein the first gear and the second gear are configured from resin.

9. The webbing take-up device of claim 1, further comprising a gear shaft integrally molded with the second gear.

10. The webbing take-up device of claim 1, further comprising an urging member that is coupled to the second gear, and that is configured so as to urge the spool in the take-up direction via the second gear and the first gear.

11. The webbing take-up device of claim 10, further comprising a support body that is configured to rotatably support the spool, the urging member being arranged at an inner side of the support body.

12. The webbing take-up device of claim 11, wherein the urging member is arranged at a support body inner side of the second gear.

13. The webbing take-up device of claim 1, wherein the second gear is urged toward a side at which the second gear is coupled to the first gear.

14. The webbing take-up device of claim 13, wherein a shaft bearing hole of the second gear is extended at the side at which the second gear is coupled to the first gear.

15. The webbing take-up device of claim 1, further comprising a support member that is configured so as to rotatably support the second gear.

16. The webbing take-up device of claim 15, further comprising an engaging member that is configured to engage with the support member, the second gear being arranged between the support member and the engaging member.

17. The webbing take-up device of claim 16, further comprising a support body that is configured by a support plate being attached to a support main body, and that rotatably supports the spool, the support member or the engaging member being attached to the support plate.
